(19) United States
(12) Patent Application Publication
(10) Pub. No.: US 2002/0138346 A1
(43) Pub. Date: Sep. 26, 2002

(54) Method of and apparatus for distributing advertisement

(75) Inventors: Toshihiro Kodaka, Kawasaki (JP); Yoshiaki Imajima, Kawasaki (JP); Mitsuru Nakajima, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/917,755

(22) Filed: Jul. 31, 2001

(30) Foreign Application Priority Data
Mar. 21, 2001 (JP) 2001-079728

(51) Int. Cl. G06F 17/60

(52) U.S. Cl. 705/14; 705/26

(57) ABSTRACT

A method of distributing an advertisement is capable of reliably producing a sales promotion effect for commodities carried on the advertisement. A consumer uses a terminal to download contents data from a contents server in step S1. A banner advertisement image is transmitted from a coupon management server to the terminal in step S2. The terminal displays contents and a banner advertisement on its display screen. Thereafter, the consumer uses the terminal to access a shop Web site server, and acquires contents data including a commodity list in step S3. The coupon management server transmits coupon information to the terminal in step S4. The terminal displays the commodity list and the coupon information on the display screen. When settling information is transmitted from the terminal to the coupon management server, the coupon management server carries out a settling process.

### BACKGROUND OF THE INVENTION

(1) Field of the Invention

The present invention relates to a method of and an apparatus for distributing an advertisement via a network, and more particularly to a method of and an apparatus for distributing an advertisement accompanied by some benefit to be given to a consumer who has seen the advertisement.

(2) Description of the Related Art

It has been highly popular to distribute information over the Internet. For example, various items of information are carried in home pages (HP) on the Internet and can be browsed by many and unspecified persons. Among those items of information available from home pages are some useful information that attracts many peoples' interests. The home pages which carry such significant information are accessed by many Internet users. The home pages that are accessed frequently serve as an effective advertising medium. For this reason, it has been customary for a number of companies to place advertisements of commodities and services in their home pages on the Internet.

Recently, the amount of information available on the Internet is rapidly increasing day by day. With the growing amount of information available on the Internet, the possibility that consumers will happen to see advertisements which simply appear in home pages is becoming lower. One solution is to give some benefit to consumers who have seen a certain advertisement, thus motivating more consumers to take a look at the advertisement.

For example, while a consumer is browsing through various home pages on the Internet, an advertisement is displayed on the display screen of the computer that the consumer is operating, and the advertiser will pay the consumer cash depending on the period of time in which the advertisement has been displayed. Since the consumer obtains money simply by seeing the advertisement on the computer, it is expected that the consumer will choose to display the advertisement on the display screen. As a result, the advertiser can have many consumers see the advertisement over the Internet.

However, just because a consumer has had an advertisement displayed on the display screen of its computer does not mean that the consumer's willingness to buy the advertised commodity or service has been aroused. Stated otherwise, even if there are many consumers who have had an advertisement displayed on their display screens in patience to obtain cash as the benefit, the advertiser cannot expect that those consumers will actually buy the advertised commodity or service.

Therefore, there has been a demand for a system for giving a consumer a benefit when the consumer who has seen an advertisement has its willingness to buy the advertised commodity or service aroused, clearly contributing to the promotion of sales of the advertised commodity or service.

### SUMMARY OF THE INVENTION

It is therefore an object of the present invention to provide a method of and an apparatus for distributing an advertisement so as to be highly effective to promote sales of the advertised commodity or service.

In order to achieve the above object, there is provided in accordance with the present invention a method of distributing an advertisement with a computer over a network, comprising the steps of managing coupon information which defines a benefit upon purchase of a given commodity and advertisement information in association with the coupon information, and transmitting the advertisement information to a terminal which is connected via the network in response to a request from the terminal, storing the coupon information associated with the advertisement information transmitted to the terminal, in association with the terminal, referring to the coupon information stored in association with the terminal and determining a benefit upon purchase of the given commodity in response to a benefit inquiry request for the given commodity from the terminal, and indicating the determined benefit to the terminal.

To accomplish the above object, there is also provided an apparatus for distributing an advertisement over a network, comprising advertisement transmitting means for managing coupon information which defines a benefit upon purchase of a given commodity and advertisement information in association with the coupon information, and transmitting the advertisement information to a terminal which is connected via the network in response to a request from the terminal, coupon information storing means for storing the coupon information associated with the advertisement information transmitted to the terminal, in association with the terminal, determining means for referring to the coupon information stored in association with the terminal and determining a benefit upon purchase of the given commodity in response to a benefit inquiry request for the given commodity from the terminal, and indicating means for indicating the determined benefit to the terminal.

The above and other objects, features, and advantages of the present invention will become apparent from the following description when taken in conjunction with the accompanying drawings which illustrate a preferred embodiment of the present invention by way of example.

### BRIEF DESCRIPTION OF THE DRAWINGS

FIG. 1 is a view showing the principles of the present invention;

FIG. 2 is a view showing a virtual coupon system according to an embodiment of the present invention;

FIG. 3 is a block diagram of a hardware arrangement of a coupon management server;

FIG. 4 is a block diagram showing an exchange of information in the virtual coupon system;

FIG. 5 is a functional block diagram of the coupon management server;

FIG. 6 is a diagram showing an example of data structure in a coupon management database;

FIG. 7 is a diagram showing an example of data structure in an advertisement database;

FIG. 8 is a diagram showing an example of data structure in a user information management database;

FIG. 9 is a diagram showing an example of data structure in a coupon issue/use management database;

FIG. 10 is a diagram showing an example of data structure in a charge settlement management database;

FIG. 11 is a diagram showing an example of data structure in a commodity/shop management database;

FIG. 12 is a diagram showing a process of registering an advertisement;

FIG. 13 is a diagram showing a process of issuing a coupon;

FIG. 14 is a flowchart of a process of issuing a coupon in the coupon management server;

FIG. 15 is a diagram showing a process of using a coupon;

FIG. 16 is a flowchart of a process of transmitting coupon information in the coupon management server;

FIG. 17 is a flowchart of a process of settling a coupon in the coupon management server;

FIG. 18 is a diagram showing a process of referring to a coupon; and

FIGS. 19(A), 19(B), and 19(C) are diagrams showing an example of views displayed on a user terminal, FIG. 19(A) showing a home page browsing view displayed on the user terminal, FIG. 19(B) an online shopping view displayed on the user terminal, and FIG. 19(C) a settlement view displayed on the user terminal.

### DESCRIPTION OF THE PREFERRED EMBODIMENT

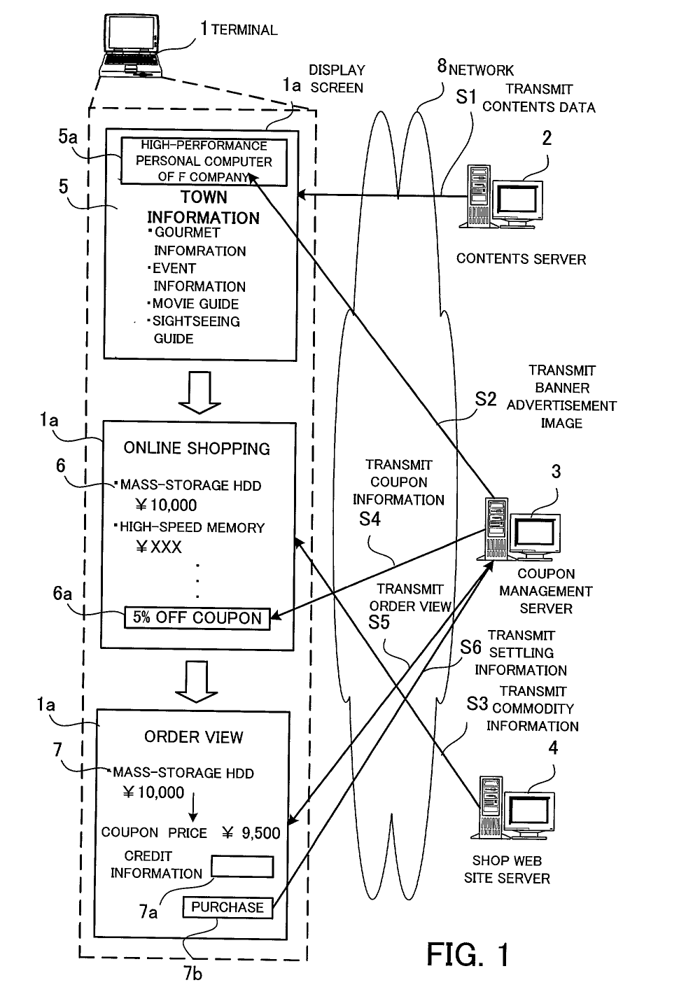

FIG. 1 shows the principles of the present invention. As shown in FIG. 1, a method of distributing an advertisement for electronic commerce transactions is carried out using a terminal 1, a contents server 2, a coupon management server 3, and a shop Web site server 4, which are interconnected by a network 8.

The method of distributing an advertisement for electronic commerce transactions will be described below with reference to FIG. 1. A consumer uses the terminal 1 to download contents from the contents server 2 in step S1. To the contents, there is related a banner advertisement that is held by the coupon management server 3. Upon receipt of the contents, the terminal 1 transmits a request to acquire the banner advertisement related to the contents to the coupon management server 3. In response to the request, the coupon management server 3 then transmits a banner advertisement image to the terminal 1 in step S2. The terminal 1 displays on its display screen 1a contents 5 and a banner advertisement 5a.

Thereafter, the consumer uses the terminal 1 to access the shop Web site server 4 and acquire contents including a commodity list in step S3. The terminal 1 sends a request (benefit inquiry request) to acquire coupon information of a commodity (the term “commodity” is used herein to refer to both commodity and service) included in the contents to the coupon management server 3. In response to the benefit inquiry request, the coupon management server 3 refers to coupon information held thereby which is associated with the terminal 1, and determines a benefit to be applied when the consumer buys the commodity. The coupon management server 3 then transmits the coupon information to the terminal 1 in step S4. The terminal 1 then displays on the display screen 1a a commodity list 6 and coupon information 6a.

The consumer then uses the terminal 1 to acquire a commodity order view from the coupon management server 3 in step S5. The display screen 1a displays price information 7 of the commodity based on the use of a coupon. The price information 7 includes a credit information entry window 7a and a purchase button 7b. When the consumer enters credit information in the credit information entry window 7a and clicks on the purchase button 7b using the terminal 1, a purchase application including settlement information is transmitted from the terminal 1 to the coupon management server 3 in step S6. As a result, the coupon management server 3 produces a sales contract about the commodity to which the determined benefit is applied, and settles the purchase of the commodity based on the sales contract.

As described above, a coupon is given as a benefit to a consumer who has seen an advertisement on its terminal, and the consumer is allowed to buy a commodity with the benefit (such as a discount or the like) based on the coupon. Accordingly, the consumer who has seen the advertisement has its willingness to buy the advertised commodity aroused. Because the coupon is used when the consumer purchases the commodity, the benefit is given only to the purchaser of the commodity, and hence the advertiser is able to cut down undue advertisement expenses.

Specific details of an embodiment of the present invention will be described below. In the description which follows, a consumer who uses a computer (terminal) that can be connected to a coupon management server via a network is referred to as a user, and a system for performing electronic commerce transactions using a coupon (online virtual coupon) as a virtual coupon system.

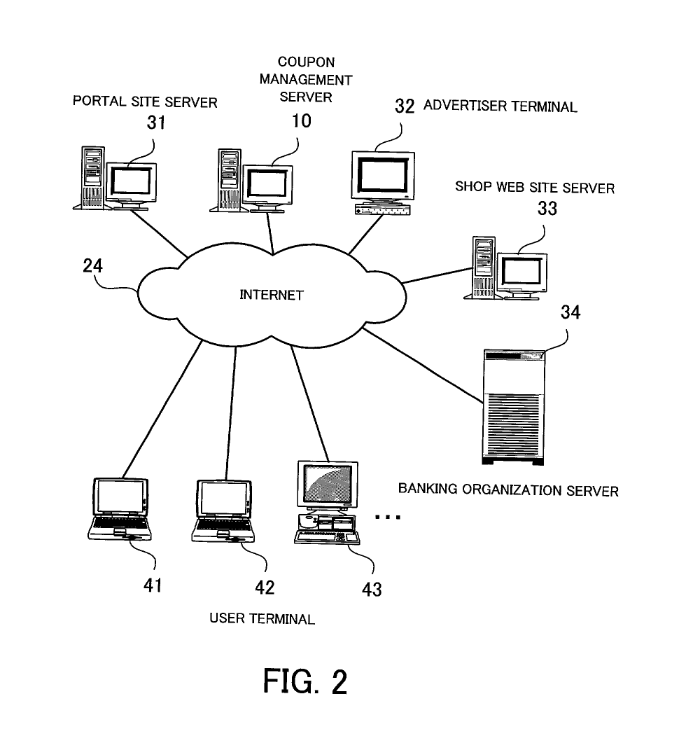

FIG. 2 shows a virtual coupon system according to an embodiment of the present invention. In the virtual coupon system, various computers are connected to each other via the Internet 24. The interconnected computers include a coupon management server 10, a portal site server 31, an advertiser terminal 32, a shop Web site server 33, a banking organization server 34, and a plurality of user terminals 41, 42, 43.

The coupon management server 10 manages electronic commerce transactions using coupons. Specifically, the coupon management server 10 distributes banner advertisements to the user terminals 41, 42, 43, and manages coupon information to be given to users who have seen advertisements. The coupon management server 10 also receives purchase applications using coupons from the user terminals 41, 42, 43, settles purchases based on the purchase applications, and transmits settled results to the shop Web site server 33.

The portal site server 31 provides the users of the user terminals 41, 42, 43 with various contents and a service for retrieving contents. The contents provided by the portal site server 31 include those carrying banner advertisements provided by the coupon management server 10.

The advertiser terminal 32 registers information of advertisements to be distributed view the Internet 24 in the coupon management server 10. The advertiser terminal 32 also registers coupon information added to advertisements and information about commodities that can be purchased with a coupon in the coupon management server 10.

The shop Web site server 33 provides contents corresponding to virtual shops for online shopping to the users of the user terminals 41, 42, 43. The contents provided by the shop Web site server 33 include information about commodities offered for sale in the virtual shops.

The banking organization server 33 performs a credit settlement based on settlement information transmitted from the coupon management server 10. The banking organization server 33 may, for example, be a server for settling purchases with a credit card in a credit company.

The user terminals 41, 42, 43 comprise computers used by general users of information communications via the Internet 24. The user terminals 41, 42, 43 have home page browsing software (browser) installed therein.

In FIG. 2, the banking organization server 34 is shown as being connected to the Internet 24. However, the banking organization server 34 may be connected to the coupon management server 10 via a dedicated line, rather than the Internet 24. If information is exchanged between the banking organization server 34 and the coupon management server 10 via a dedicated line, rather than the Internet 24, then exchanged settlement information is protected with better security.

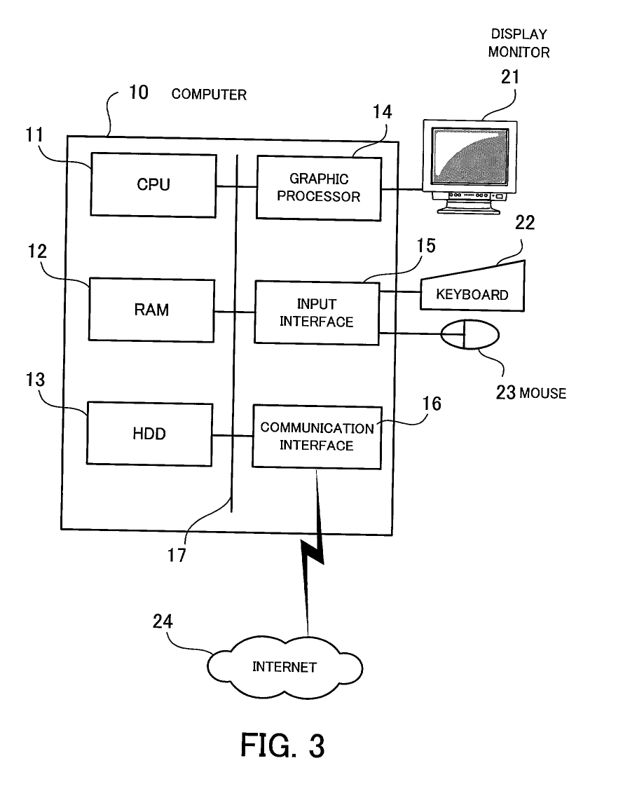

FIG. 3 shows in block form a hardware arrangement of the coupon management server 10. The coupon management server 10 is controlled in its entirety by a CPU 11. To the CPU 11, there are connected a RAM (Random-Access Memory) 12, a hard disk drive (HDD) 13, a graphic processor 14, an input interface 15, and a communication interface 16 via a bus 17.

The RAM 12 temporarily stores at least a portion of an OS (Operating System) program and application programs that are to be executed by the CPU 11. The RAM 12 also stores various data required in processing sequences by the CPU 11. The HDD 13 stores various items of information required for coupon management.

A display monitor 21 is connected to the graphic processor 14. The graphic processor 14 displays an image on the display screen of the display monitor 21 according to an instruction from the CPU 11. To the input interface 15, there are connected a keyboard 22 and a mouse 23. The input interface 15 transmits signals sent from the keyboard 22 and the mouse 23 to the CPU 11 via the bus 17.

The communication interface 16 is connected to the Internet 24, and transmits data to and receives data from other computers via the Internet 24.

Only the hardware arrangement of the coupon management server 10 is illustrated in FIG. 3. However, each of the other computers including the portal site server 31, the advertiser terminal 32, the shop Web site server 33, the banking organization server 34, and the user terminals 41, 42, 43 may be of a hardware arrangement similar to the hardware arrangement of the coupon management server 10. However, the HDD of each computer stores data and programs depending on the functions performed by the computer. For example, the HDD of the portal site server 31 stores contents of a home page.

The hardware arrangement shown in FIG. 3 is effective to perform processing functions of the embodiment of the present invention.

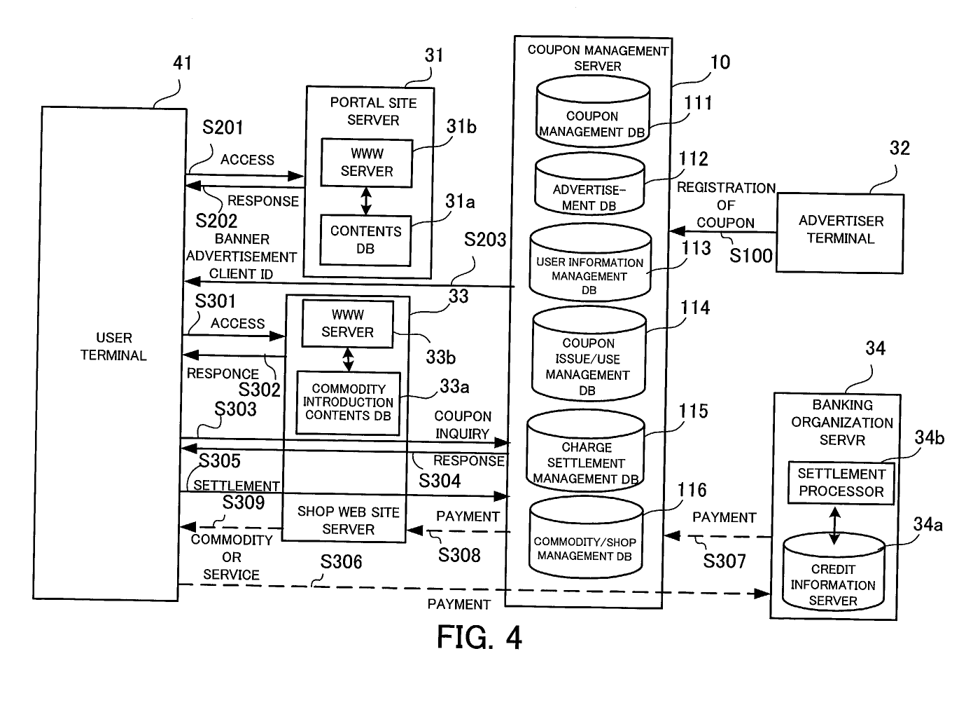

FIG. 4 shows an exchange of information in the virtual coupon system. FIG. 4 illustrates data stored in the computers and data exchanged between the computers. Procedures that are carried out offline, e.g., the delivery of a commodity, are indicated by the broken lines in FIG. 4.

As shown in FIG. 4, the coupon management server 10 has a coupon management database (DB) 111, an advertisement DB 112, a user information management DB 113, a coupon issue/use management DB 114, a charge settlement management DB 115, and a commodity/shop management DB 116. The coupon management DB 111 stores registered data of coupons corresponding to banner advertisements. The advertisement DB 112 stores registered graphic data of banner advertisements to be displayed on the user terminals. The user information management DB 113 stores registered information of users who have seen banner advertisements. The coupon issue/use management DB 114 stores information relative to an association between users and coupons given to the users. The charge settlement management DB 115 stores charged amounts of money for commodities that have been sold. The commodity/shop management DB 116 stores registered data of commodities for which coupons can be used, and shops for selling those commodities. Processing functions of the coupon management server 10 will be described later on.

The portal site server 31 has a contents DB 31a which stores contents data to be provided to users. The portal site server 31 also has a processing function as a WWW (World Wide Web) server 31b.

The shop Web site server 33 has a commodity introduction contents DB 33a. The shop Web site server 33 also has a processing function as a WWW server 33b.

The banking organization server 34 has a credit information DB 34a and a settlement processor 34b. The credit information DB 34a stores registered outstanding balances of users available for credit. The settlement processor 34b performs credit settlements for users based on a request from the coupon management server 10. Specifically, the settlement processor 34b withdraws a charged amount of money from the user's account in a bank and transfers the withdrawn amount of money to the account of the operator (coupon manager) of the coupon management server 10.

Exchanges of information in the above virtual coupon system can be divided into various steps, i.e., the step of registering a coupon, the steps of acquiring a coupon, and the steps of using a coupon.

The step of registering a coupon (S100) is carried out as follows: The advertiser terminal 32 accesses the coupon management server 10 on an interactive basis, and registers coupon information in the coupon management DB 111 in step S201. The advertiser can desirably register, delete, and change coupon information, using the advertiser terminal 32.

The steps of acquiring a coupon (S201 through S203) are carried out as follows: The user terminal 41 accesses the portal site server 31 for specifying desired contents in step S201. In the portal site server 31, the WWW server 31b acquires the specified contents from the contents DB 31a, and transmits response data including the acquired contents to the user terminal 41 in step S202. At this time, a banner advertisement in the advertisement DB 112 is related to the contents transmitted to the user terminal 41. When the user terminal 41 transmits a request to acquire the banner advertisement to the coupon management server 10, the coupon management server 10 transmits an identifier (client ID) for uniquely identifying the banner advertisement and the user terminal 41 to the user terminal 41 in step S203. The client ID may be transmitted in the form of a cookie, for example. The cookie is an information file transmitted from a Web site and stored in the hard disk of a terminal which is running a Web browser. Upon transmission of the banner advertisement, the coupon management server 10 registers coupon information in association with the user terminal 41. The coupon information can be used only when there is a request to purchase a commodity from the user terminal 41.

The steps of using a coupon (S301 through S309) are carried out as follows: The user terminal 41 accesses the shop Web site server 33 for specifying desired contents in step S301. In the shop Web site server 33, the WWW server 33b acquires the specified contents from the commodity introduction contents DB 33a, and transmits response data including the acquired contents to the user terminal 41 in step S302. The user terminal 41 transmits a coupon inquiry to the coupon management server 10 in step S303. The coupon management server 10 refers to the coupon issue/use management DB 114, and transmits a response to the coupon inquiry to the user terminal 41 in step S304. The user terminal 41 transmits settlement information to the coupon management server 10 in response to an entry action made by the user in step S305. The coupon management server 10 produces a sales contract about a commodity based on the usage of a coupon, and settles the purchase of the commodity based on the sales contract. In the settling process, the user makes a payment to the banking organization which runs the banking organization server 34 in step S306. The payment is transferred from the banking organization to the administrator of the coupon management server 10 in step S307, and then transferred from the administrator of the coupon management server 10 to the administrator of the shop Web site server 33 in step S308. The administrator of the shop Web site server 33 then provides the commodity or service to the user of the user terminal 41 in step S309.

Functions of the coupon management server 10 which serve to carry out the processes shown in FIG. 4 will be described below.

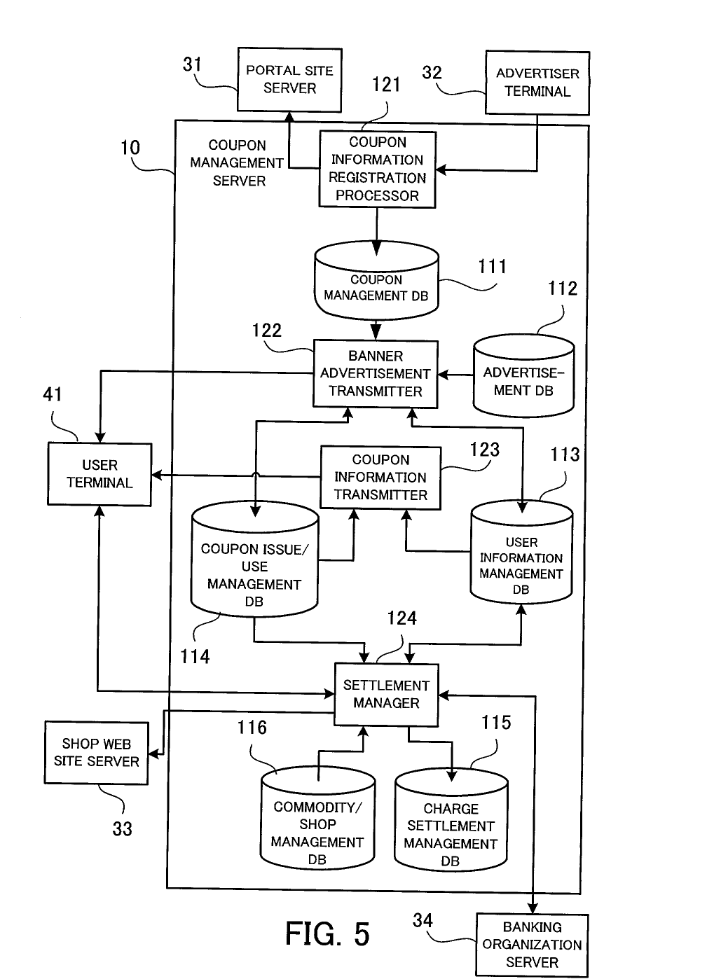

FIG. 5 shows in block form the coupon management server 10. The coupon management server 10 has, in addition to the DBs shown in FIG. 4, a coupon information registration processor 121, a banner advertisement transmitter 122, a coupon information transmitter 123, and a settlement manager 124.

The coupon information registration processor 121 receives coupon information sent from the advertiser terminal 32, and registers the received coupon information in the coupon management DB 111. The coupon information includes a coupon ID, coupon discount details, etc. The coupon information registration processor 121 also asks the portal site server 31 to carry an advertisement.

The banner advertisement transmitter 122 acquires a banner advertisement based on a request from the user terminal 41 from the advertisement DB 112, and transmits the banner advertisement and the client ID to the user terminal 41. The banner advertisement transmitter 122 refers to the coupon management DB 111, and issues a coupon in association with the user of the user terminal 41. The banner advertisement transmitter 122 registers information of the issued coupon in the coupon issue/use management DB 114. If the user is a new user, then the banner advertisement transmitter 122 registers a record corresponding to the new user in the user information management DB 113.

The coupon information transmitter 123 acquires coupon information from the coupon issue/use management DB 114 in response to a coupon information acquisition request from the user terminal 41. The coupon information transmitter 123 transmits the acquired coupon information to the user terminal 41.

The settlement manager 124 transmits settlement entry view data to the user terminal 41 in response to a settlement view acquisition request from the user terminal 41. When settlement information is transmitted from the user terminal 41, the settlement manager 124 performs a settling process based on the transmitted settlement information. In the present embodiment, the settlement manager 124 asks the banking organization server 34 to perform a settling process.

When the settlement manager 124 receives a settlement completion notice from the banking organization server 34, the settlement manager 124 transfers the settlement completion notice to the shop Web site server 33.

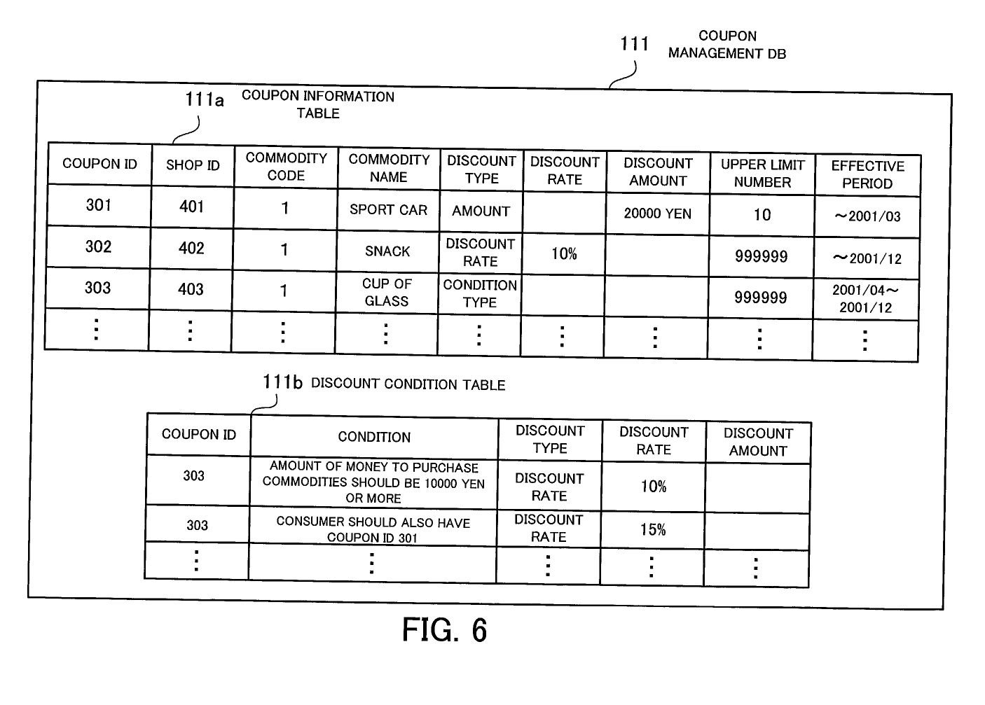

Data stored in the coupon management server 10 will be described below with reference to FIGS. 6 through 11.

FIG. 6 shows an example of data structure in the coupon management DB 111. The coupon management DB 111 includes a coupon information table 111a and a discount condition table 111b.

The coupon information table 111a has columns of coupon IDs, shop IDs, commodity codes, commodity names, discount types, discount rates, discounted amounts, upper limit numbers, and effective periods.

The column of coupon IDs stores registered unique identifiers (coupon IDs) for respective coupon types. In the illustrated example, coupon IDs “301”, “302”, “303”, . . . are registered in the column of coupon IDs.

The column of shop IDs stores registered identifiers of shops (shop IDs) which issue coupons, in association with coupon IDs. In the illustrated example, shop IDs “401”, “402”, “403”, . . . are registered in the column of shop IDs.

The column of commodity codes stores registered commodity codes for respective coupon types. In the illustrated example, article codes “1”, “1”, “1”, . . . are registered in the column of commodity codes in association with the respective coupon IDs “301”, “302”, “303”, . . . .

The column of commodity names stores registered commodity names for respective coupon types in association with coupon types. In the illustrated example, commodity names “sports car”, “snack”, “cup of glass”, . . . are registered in the column of commodity names in association with the respective coupon IDs “301”, “302”, “303”, . . . .

The column of discount types stores registered discount types for respective coupon types, which are indicative of discount methods in association with coupon types. For example, the discount types include a method of setting a discount rate (discount type: discount rate), a method of setting a discount amount (discount type: amount), and a method of changing how to calculate a discount amount according to a condition (discount type: condition type). Conditions in the condition type are defined in the discount condition table 111b. In the illustrated example, discount types “amount”, “discount rate”, “condition type”, . . . are registered in the column of discount types in association with the respective coupon IDs “301”, “302”, “303”, . . . .

The column of discount rates stores registered discount rates for respective coupon types with respect to which the discount type “discount rate” is registered, in association with coupon IDs. In the illustrated example, the discount rate “10%” is registered in association with the coupon ID “302”.

The column of discount amounts stores registered discount rates (in the unit of yen) for respective coupon types with respect to which the discount type “amount” is registered, in association with coupon IDs. In the illustrated example, the discount amount “20000 (yen)” is registered in association with the coupon ID “301”.

The column of upper limit numbers stores registered upper limit numbers of coupons for one user for respective coupon attributes, in association with coupon IDs. In the illustrated example, upper limit numbers “10”, “999999”, “999999”, . . . are registered in the column of upper limit numbers in association with the respective coupon IDs “301”, “302”, “303”, . . . .

The column of effective periods stores registered effective periods of coupons for respective coupon types, in association with coupon IDs. An effective period may be defined by both a starting date and an ending date, or only an ending date. Alternatively, an effective period may be defined as a period from the date of issue of a coupon. In the illustrative example, effective periods “through 2001/03” (effective from the date of issue until the end of March 2001), “through 2001/12” (effective from the date of issue until the end of December 2001), “2001/4 through 2001/12” (effective from April 2001 until the end of December 2001), . . . are registered in the column of effective periods in association with the respective coupon IDs “301”, “302”, “303”, . . . .

The discount condition table 111b has columns of coupon IDs, conditions, discount types, discount rates, and discount amounts.

The column of coupon IDs stores registered coupon IDs. In the embodiment, a plurality of conditions can be set for each coupon type. Therefore, a plurality of records can be registered in the discount condition table 111b for each coupon ID. In the illustrated example, coupon IDs “303”, “303”, . . . are registered in the column of coupon IDs.

The column of conditions stores registered discount conditions in association with coupon IDs. For example, the discount conditions “the amount of money spent to purchase commodities in a shop should be xxx yen or more” and “the consumer should have a coupon of coupon ID xxx” may be set. In the illustrated example, the discount conditions “the amount of money spent to purchase commodities should be 10000 yen or more” and “the consumer should also have a coupon of coupon ID 301” are set in association with the coupon ID “303”.

The column of discount types stores discount types for respective discount conditions, which are indicative of discount methods in association with coupon IDs and discount conditions. For example, the discount types include a method of setting a discount rate (discount type: discount rate), and a method of setting a discount amount (discount type: amount). In the illustrated example, the discount type “discount rate” is set in the column of discount types in association with the coupon ID “303” and the discount condition “the amount of money spent to purchase commodities should be 1000 yen or more”, and the discount type “discount rate” is set in the column of discount types in association with the coupon ID “303” and the discount condition “the consumer should also have a coupon of coupon ID 301”.

The column of discount rates stores discount rates for respective coupon types with respect to which the discount type “discount rate” has been set. In the illustrated example, the discount rate “10%” is set in the column of discount rates in association with the coupon ID “303” and the discount condition “the amount of money spent to purchase commodities should be 1000 yen or more”, and the discount rate “15%” is set in the column of discount rates in association with the coupon ID “303” and the discount condition “the consumer should also have a coupon of coupon ID 301”.

The column of discount amounts stores discount amounts (in the unit of yen) for respective coupon types with respect to which the discount type “amount” is set, in association with coupon IDs and discount conditions. In the illustrated example, the column of discount amounts stores no record for the discount type “amount”. Therefore, the discount condition table 111b contains no data with respect to which discount amounts are set.

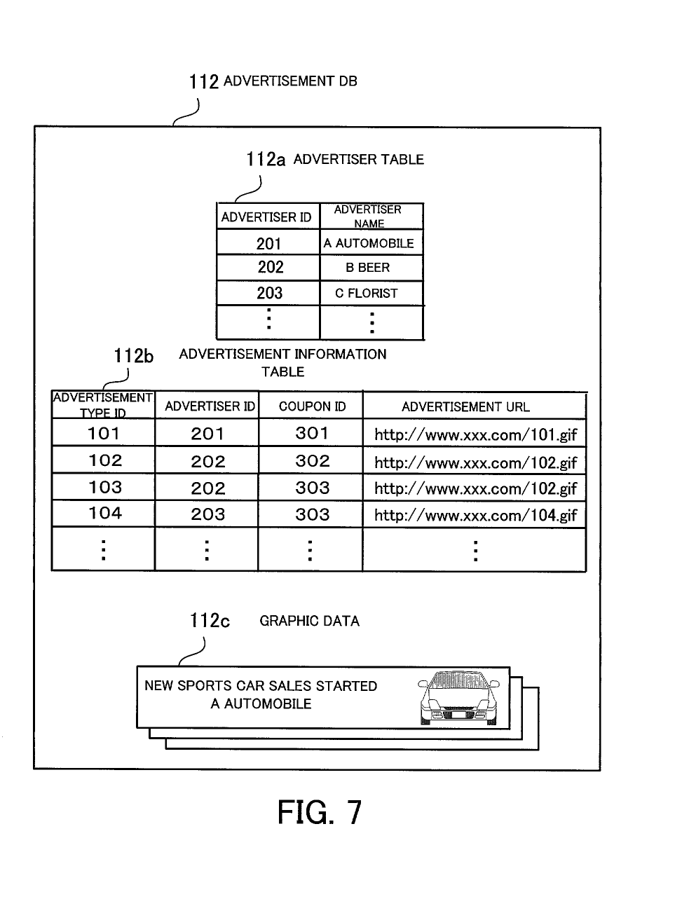

FIG. 7 shows an example of data structure in the advertisement DB 112. The advertisement DB 112 includes an advertiser table 112a, an advertisement information table 112b, and graphic data 112c.

The advertiser table 112a has columns of advertiser IDs and advertiser names.

The column of advertiser IDs stores registered identifiers of companies (advertiser IDs) which have asked the coupon management server 10 to carry banner advertisements. In the illustrated example, the column of advertiser IDs stores advertise IDs “201”, “202”, “203”, . . . .

The column of advertiser names stores registered names of companies which have asked the coupon management server 10 to carry banner advertisements, in association with advertiser IDs. In the illustrated example, the column of advertiser names stores a registered advertiser name “A automobiles” in association with the advertiser ID “201”, a registered advertiser name “B beer” in association with the advertiser ID “202”, and a registered advertiser name “C florist” in association with the advertiser ID “203”.

The advertisement information table 112b has columns of advertisement type IDs, advertiser IDs, coupon IDs, and advertisement URLs (Uniform Resource Locators).

The column of advertisement type IDs stores registered identifiers (advertisement type IDs) for uniquely identifying advertisements. In the illustrated example, IDs “101”, “102”, “103”, “104”, . . . are registered in the column of advertisement type IDs.

The column of advertiser IDs stores registered identifiers (advertiser IDs) for identifying advertisers in association with advertisement type IDs. In the illustrated example, the column of advertiser IDs stores a registered advertiser ID “201” in association with the advertisement type ID “101”, a registered advertiser ID “202” in association with the advertisement type ID “102”, a registered advertiser ID “202” in association with the advertisement type ID “103”, and a registered advertiser ID “203” in association with the advertisement type ID “104”.

The column of coupon IDs stores registered unique identifiers (coupon IDs) for respective coupon types in association with advertisement type IDs. In the illustrated example, the column of coupon IDs stores a registered coupon ID “301” in association with the advertisement type ID “101”, a registered coupon ID “302” in association with the advertisement type ID “102”, a registered coupon ID “303” in association with the advertisement type ID “103”, and a registered coupon ID “303” in association with the advertisement type ID “104”.

The column of advertisement URLs stores registered URLs for graphic data for banner advertisements in association with advertisement type IDs. In the illustrated example, the column of advertisement URLs stores a registered advertisement URL “http://www.xxx.com/101.gif” in association with the advertisement type ID “101”, a registered advertisement URL “http://www.xxx.com/102.gif” in association with the advertisement type ID “102”, a registered advertisement URL “http://www.xxx.com/102.gif” in association with the advertisement type ID “103”, and a registered advertisement URL “http://www.xxx.com/104.gif” in association with the advertisement type ID “104”. In this example, one advertisement URL is associated with the two advertisement type IDs “102”, “103”. This means that when the user sees one banner advertisement, the user is given two coupons.

The graphic data 112c comprise a plurality of graphic data to be transmitted as banner advertisements to the user terminal. The graphic data 112c are stored in locations represented by advertisement URLs.

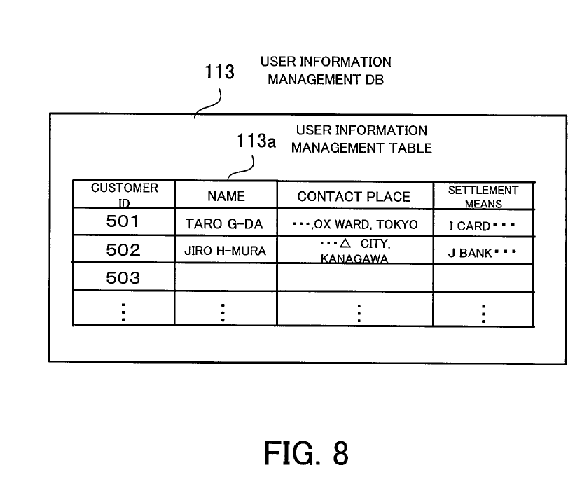

FIG. 8 shows an example of data structure in the user information management DB 113. The user information management DB 113 includes a user information management table 113a. The user information management table 113a has columns of customer IDs, names, contact places, and settling means.

The column of customer IDs stores registered identifiers (customer IDs) of customers to whom coupons are issued. In the illustrated example, customer IDs “501”, “502”, “503”, . . . are registered in the column of customer IDs.

The column of names stores registered names of customers to whom coupons are issued, in association with customer IDs. Only the names of users who have purchased commodities in the past are registered in the column of names. In the illustrated example, the column of names stores a registered name “Taro G-da” in association with the customer ID “501”, a registered name “Jiro H-mura” in association with the customer ID “502”, and no registered name in association with the customer ID “503”.

The column of contact places stores registered contact places of customers to whom coupons are issued, in association with customer IDs. The contact places may be residential addresses or telephone numbers. Only the contact places of users who have purchased commodities in the past are registered in the column of contact places. In the illustrated example, the column of contact places stores a registered contact place “. . . , ◯x Ward, Tokyo” in association with the customer ID “501”, a registered contact place “. . . , Δ City, Kanagawa” in association with the customer ID “502”, and no registered contact place in association with the customer ID “503”.

The column of settling means stores registered settling means of customers to whom coupons are issued, in association with customer IDs. If a settling means is a credit card, then the number of the credit card is registered as the settling means. If a settling means is a withdrawal from a bank account, then the name of the bank and the name of its branch where the bank account is open, the type of the bank account (a saving account, a checking account, or the like), and the account number. In the illustrated example, the column of settling means stores a registered settling means “I card . . . ” in association with the customer ID “501”, a registered settling means “J bank . . . ” in association with the customer ID “502”, and no registered settling means in association with the customer ID “503”.

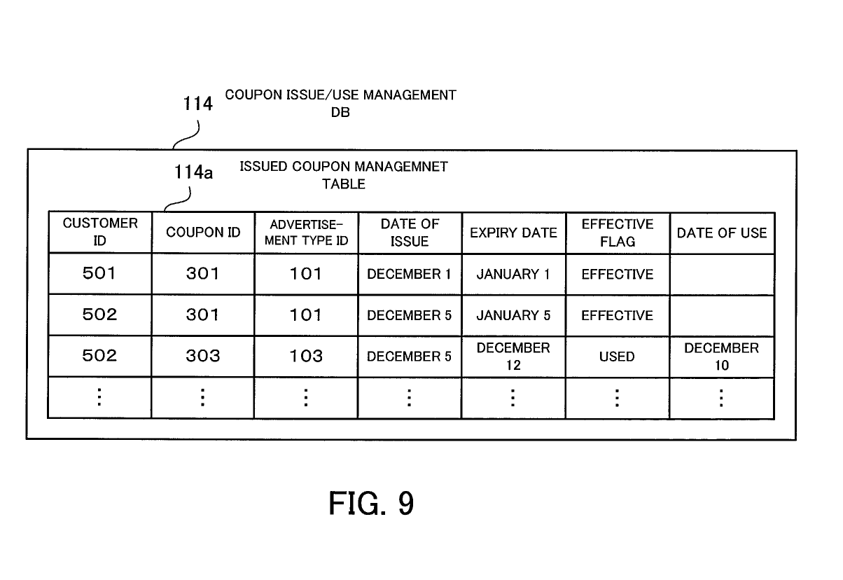

FIG. 9 shows an example of data structure in the coupon issue/use management DB 114. The coupon issue/use management DB 114 includes an issued coupon management table 114a. The issued coupon management table 114a has columns of customer IDs, coupon IDs, advertisement type IDs, dates of issue, dates of expiration, effective flags, and dates of use.

The column of customer IDs stores registered customer IDs of users who have issued coupons. In the illustrated example, issued coupons of customer IDs “501”, “502”, “502”, . . . are registered in the column of customer IDs.

The column of coupon IDs stores registered coupon IDs of coupons issued to users in association with customer IDs. In the illustrated example, the column of coupon IDs stores a registered coupon ID “301” in associated with the issued coupon of the customer ID “501”, and registered coupon IDs “301”, “303” respectively in associated with the two issued coupons of the customer ID “502”.

The column of advertisement type IDs stores registered identifiers (advertisement IDs) of advertisements for which coupons are issued, in association with sets of customer IDs and coupon IDs. In the illustrated example, the column of advertisement type IDs stores a registered advertisement type ID “101” in association with the customer ID “501” and the issued coupon having the coupon ID “301”, a registered advertisement type ID “101” in association with the customer ID “502” and the issued coupon having the coupon ID “301”, and a registered advertisement type ID “103” in association with the customer ID “502” and the issued coupon having the coupon ID “303”.

The column of dates of issue stores registered dates of issue of coupons in association with sets of customer IDs and coupon IDs. In the illustrated example, the column of dates of issue stores a registered date of issue “December 1” in association with the customer ID “501” and the issued coupon having the coupon ID “301”, a registered date of issue “December 5” in association with the customer ID “502” and the issued coupon having the coupon ID “301”, and a registered date of issue “December 5” in association with the customer ID “502” and the issued coupon having the coupon ID “303”.

The column of expiry dates stores registered expiry dates of issued coupons in association with sets of customer IDs and coupon IDs. In the illustrated example, the column of expiry dates stores a registered expiry date “January 1” in association with the customer ID “501” and the issued coupon having the coupon ID “301”, a registered expiry date “January 5” in association with the customer ID “502” and the issued coupon having the coupon ID “301”, and a registered expiry date “December 12” in association with the customer ID “502” and the issued coupon having the coupon ID “303”.

The column of effective flags stores registered states of issued coupons in association with sets of customer IDs and coupon IDs. The states of issued coupons include an effective state, an ineffective state, a used state, etc. The effective state represents that the coupon can be used. The ineffective state represents that the coupon cannot be used, e.g., the expiry date has come. The used state represents that a transaction using the coupon has been carried out. In the illustrated example, the column of effective flags stores a registered effective flag “effective” in association with the customer ID “501” and the issued coupon having the coupon ID “301”, a registered effective flag “effective” in association with the customer ID “502” and the issued coupon having the coupon ID “301”, and an effective flag “used” in association with the customer ID “502” and the issued coupon having the coupon ID “303”.

The column of dates of use stores registered dates of use of issued coupons with respect to which the effective flags represent the used state. In the illustrated example, the date of use “December 10” is registered in the column of dates of use in association with the customer ID “502” and the issued coupon having the coupon ID “303”.

In the example shown in FIG. 9, the data of the dates of issue, the expiry dates, and the dates of use are indicated by months and dates for the sake of brevity. However, these data may be indicated by years, months, and dates, possibly with the addition of time data.

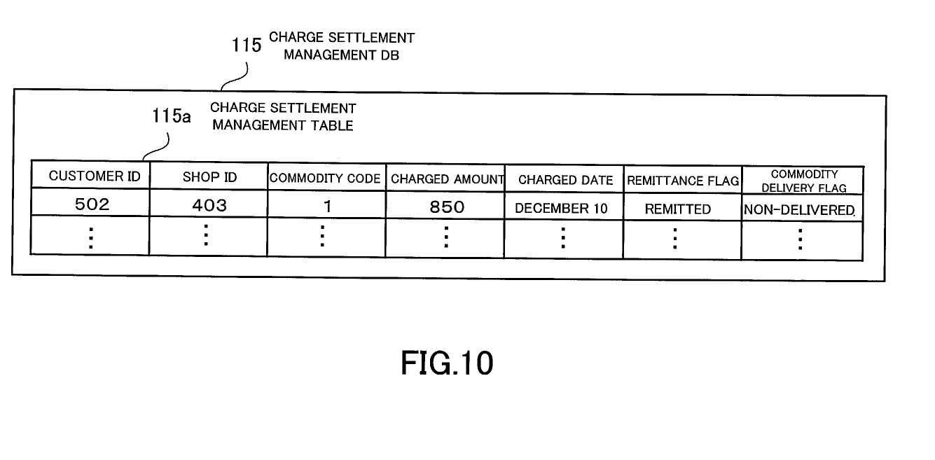

FIG. 10 shows an example of data structure in the charge settlement management DB 115. The charge settlement management DB 115 includes a charge settlement management table 115a. The charge settlement management table 115a has columns of customer IDs, shop IDs, commodity codes, charged amounts, charged dates, remittance flags, and commodity delivery flags.

The column of customer IDs stores registered customer IDs of users who have settled payments using coupons. In the illustrated example, the column of customer IDs stores a registered customer ID “502”.

The column of shop IDs stores shop IDs of shops which have issued coupons used by users for settling payments, in association with customer IDs. In the illustrated example, the column of shop IDs stores a registered shop ID “403” in association with the customer ID “502”.

The column of commodity codes stores registered commodity codes of commodities that can be settled using coupons by users, in association with sets of customer IDs and shop IDs. In the illustrated example, the column of commodity codes stores a registered commodity code “1” in association with the customer ID “502” and the shop ID “403”.

The column of charged amounts stores registered amounts charged for users who have purchased commodities using coupons, in association with sets of customer IDs, shop IDs, and commodity codes. In the illustrated example, the column of charged amounts stores a registered charged amount “850 (yen)” in association with the customer ID “502”, the shop ID “403”, and the commodity code “1”.

The column of charged dates stores registered dates for charging users who have purchased commodities using coupons, in association with sets of customer IDs, shop IDs, and commodity codes. In the illustrated example, the column of charged dates stores a registered charged date “December 10” in association with the customer ID “502”, the shop ID “403”, and the commodity code “1”.

The column of remittance flags stores registered information (remittance flags) indicative of whether charged amounts have been remitted from the administrator of the coupon management server 10 to shops which sell commodities or not, in association with sets of customer IDs, shop IDs, and commodity codes. The remittance flags include a flag indicative of a remitted state and a flag indicative of a non-remitted state. If a charged amount has been remitted, a remittance flag indicative of a remitted state is registered, and if a charged amount has not been remitted, a remittance flag indicative of a non-remitted state is registered. In the illustrated example, the column of remittance flags stores a registered remittance flag indicative of a remitted state in association with the customer ID “502”, the shop ID “403”, and the commodity code “1”.

The column of commodity delivery flags stores registered information (commodity delivery flags) indicative of whether commodities have been delivered from shops to users or not, in association with sets of customer IDs, shop IDs, and commodity codes. The commodity delivery flags include a flag indicative of a delivered state and a flag indicative of a non-delivered state. If a notice representing that the commodity has been delivered from the shop is received, a commodity delivery flag indicative of a delivered state is registered, and if a notice representing that the commodity has been delivered from the shop is not received, a commodity delivery flag indicative of a non-delivered state is registered. In the illustrated example, the column of commodity delivery flags stores a registered commodity delivery flag indicative of a non-delivered state in association with the customer ID “502”, the shop ID “403”, and the commodity code “1”.

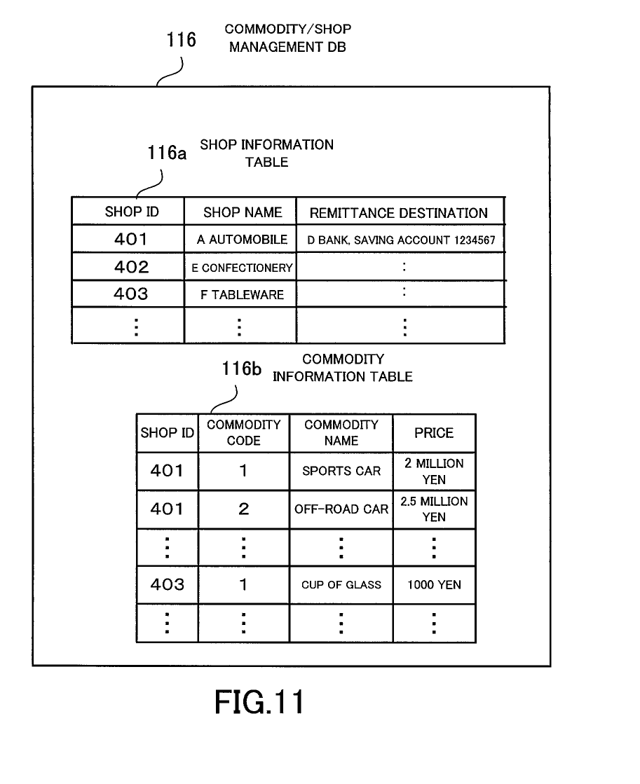

FIG. 11 shows an example of data structure in the commodity/shop management DB 116. The commodity/shop management DB 116 includes a shop information table 116a and a commodity information table 116b.

The shop information table 116a has columns of shop IDs, shop names, and remittance destinations.

The column of shop IDs stores registered identifiers (shop IDs) for respective shops which issue coupons. In the illustrated example, the column of shop IDs stores registered shop IDs “401”, “402”, “403”, . . . .

The column of shop names stores registered names of shops which issue coupons, in association with shop IDs. In the illustrated example, the column of shop names stores a registered shop name “A automobiles” in association with the shop ID “401”, a registered shop name “E confectionery” in association with the shop ID “402”, and a registered shop name “F tableware” in association with the shop ID “403”.

The column of remittance destinations stores registered accounts to which charged amounts are to be remitted for shops which issue coupons, in association with shop IDs. In the illustrated example, the column of remittance destinations stores a remittance destination “D bank, saving account 1234567” in association with the shop ID “401”.

The commodity information table 116b has columns of shop IDs, commodity codes, commodity names, and prices.

The column of shop IDs stores registered identifiers (shop IDs) for respective shops which issue coupons. In the illustrated example, the column of shop IDs stores registered shop IDs “401”, “402”, “403”, . . . .

The column of commodity codes stores registered codes (commodity codes) of commodities for sale in shops, in association with shop IDs. The commodity codes may be set to identify commodities in each shop. In the illustrated example, the column of commodity codes stores registered commodity codes “1”, “2” in association with a shop ID “401”.

The column of commodity names stores registered names (commodity names) of commodities for sale in shops, in association with sets of shop IDs and commodity codes. In the illustrated example, the column of commodity names stores a registered commodity name “sports car” in association with the shop ID “401” and the commodity code “1”, a registered commodity name “off-road car” in association with the shop ID “401” and the commodity code “2”, and a registered commodity name “cup of glass” in association with the shop ID “403” and the commodity code “1”.

The column of prices stores registered prices of commodities in association with sets of shop IDs and commodity codes. In the illustrated example, the column of prices stores a registered price “2 million yen” in association with the shop ID “401” and the commodity code “1”, a registered price “2.5 million yen” in association with the shop ID “401” and the commodity code “2”, and a registered price “1000 yen” in association with the shop ID “403” and the commodity code “1”.

Advertisements accompanied by coupons are distributed and electronic commerce transactions using coupons are carried out, using the data stored in the above databases. Processes of distributing advertisements and carrying out electronic commerce transactions according to the present invention will be described below. It is assumed in the present embodiment that there is a linkup between an advertiser and a shop, and the shop helps promote the sales of products of the advertiser. For example, a beer company applies a coupon to an advertisement for its own beers, and the coupon can be used to purchase a cup of glass for sale by a tableware company. The beer company benefits from having the advertisement seen by many consumers for the purpose of advertising its commodities, and the tableware company benefits from allowing consumers to purchase its commodities using coupons for the purpose of increasing the number of sold commodities. If the benefit (discount rate or the like) obtained by using coupons is increased, then the beer company may pay money to the tableware company thereby to prevent the tableware company from suffering disadvantages.

First, a process of registering an advertisement will be described below.

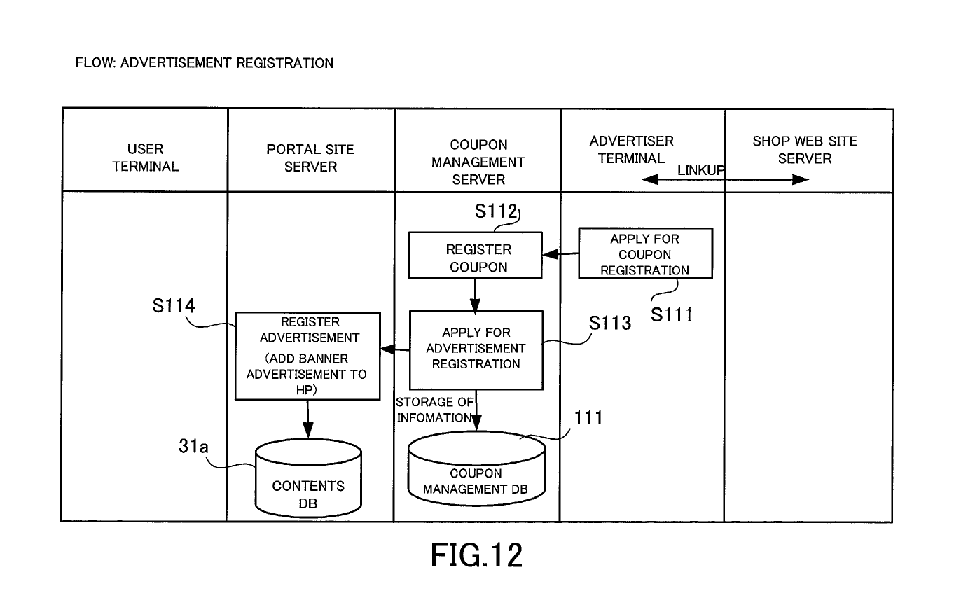

FIG. 12 shows a process of registering an advertisement. The advertiser uses the advertiser terminal 32 to apply for a coupon registration with the coupon management server 10 in step S111. In the coupon management server 10, the coupon information registration processor 121 shown in FIG. 5 registers the details of the application from the advertiser terminal 32 in the coupon management DB 111 in step S112. The coupon information registration processor 121 applies an advertisement registration with the portal site server 31, and registers the details of the application in the advertisement DB 112 in step S113. The WWW server 31b of the portal site server 31 which has received the application for the advertisement registration adds the advertisement to the home page of the portal site, and registers the data of the home page in the contents DB 31a. Specifically, the WWW server 31b registers an URL representing graphic data in the advertisement DB 112 of the coupon management server 10 as an inline image in an area of the HTML (Hyper-Text Markup Language) of the home page where a banner advertisement is to be displayed, in step S144.

A process of issuing a coupon to the user will be described below.

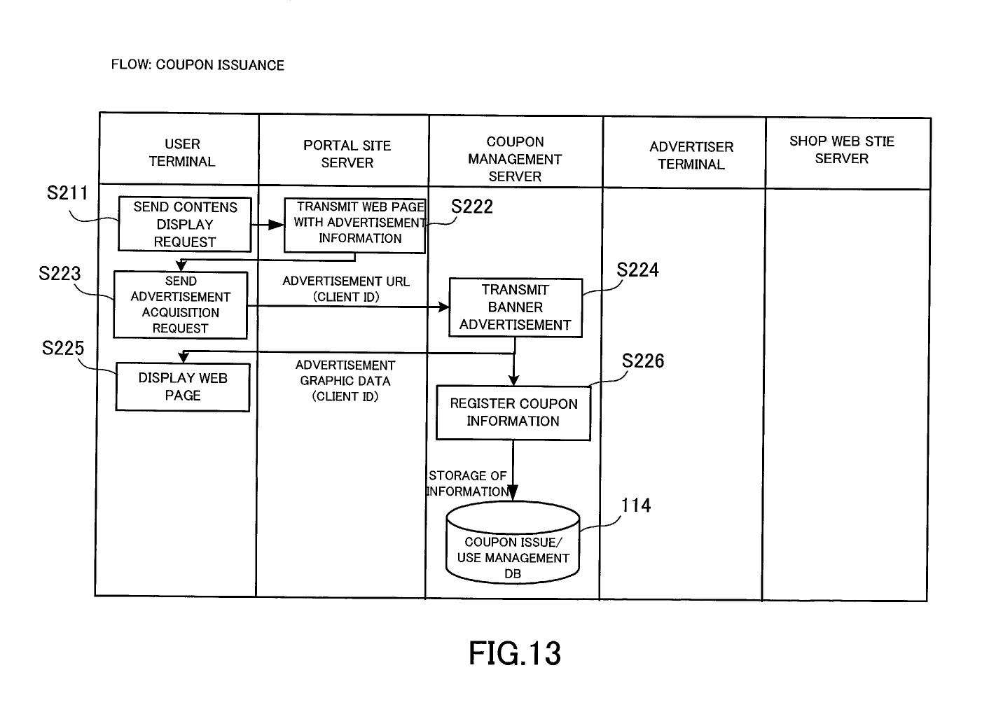

FIG. 13 shows a process of issuing a coupon. The user uses the user terminal 41 to transmits a request to display contents to the portal site server 31 in step S211. In response to the request to display contents, the portal site server 31 transmits a Web page with advertisement information to the user terminal 41 in step S222. The user terminal 41 specifies the URL of the advertisement set as an inline image in the Web page, and sends a request to acquire graphic image to the coupon management server 10 in step S223.

If the present access from the user terminal 41 to the coupon management server 10 is the second or subsequent access, then the user terminal 41 transmits the client ID together with the request to acquire graphic image to the coupon management server 10. The client ID is stored as a cookie in the user terminal 41.

The coupon management server 10 transmits the graphic data of the advertisement to the user terminal 41 in step S224. If no client ID is contained in the request to acquire graphic image, i.e., if the present access from the user terminal 41 to the coupon management server 10 is the first access, then the client ID is transmitted together with the graphic data. For example, the client ID is transmitted as a cookie. The user terminal 41 displays the graphic data of the advertisement transmitted from the portal server 31, together with the graphic data of the advertisement transmitted from the coupon management server 10 in step S225. The coupon management server 10 registers information about an issued coupon in the coupon issue/use management DB 114, from the client ID (cookie information) and the graphic data of the banner advertisement, in step S226.

A process of issuing a coupon in the coupon management server 10 will be described in detail below.

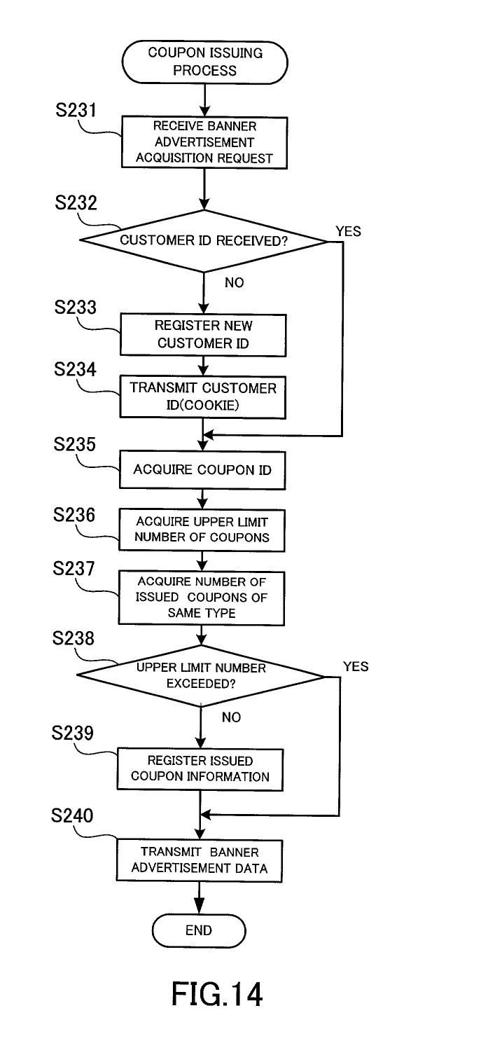

FIG. 14 is a flowchart of a process of issuing a coupon in the coupon management server 10. The process shown in FIG. 14 will be described below in a sequence according to step numbers.

[step S231] The banner advertisement transmitter 122 receives a request to acquire a banner advertisement.

[step S232] The banner advertisement transmitter 122 determines whether it has received a customer ID together with the request to acquire a banner advertisement or not. If the banner advertisement transmitter 122 has received a customer ID, then control goes to step S235. If the banner advertisement transmitter 122 has not received a customer ID, then control goes to step S233.

[step S233] The banner advertisement transmitter 122 registers a new customer ID in the user information management DB 113.

[step S234] The banner advertisement transmitter 122 transmits the customer ID registered in step S233 as a cookie to the user terminal 41.

[step S235] The banner advertisement transmitter 122 refers to the advertisement information table 112b (see FIG. 7) of the advertisement DB 112, and acquires a coupon ID corresponding to the URL of the requested banner advertisement. If there are a plurality advertisement URLs registered, then the banner advertisement transmitter 122 acquires respective coupon IDs corresponding to the URLs. For example, if the advertisement information table 112b stores the data shown in FIG. 7 and the advertisement URL “http://www.xxx.com.102.gif” is specified, then the banner advertisement transmitter 122 acquires two coupon IDs “302”, “303”.

[step S236] The banner advertisement transmitter 122 refers to the coupon information table 111a (see FIG. 6) of the coupon management DB 111, and acquires the upper limit number corresponding to the coupon ID acquired in step S235.

[step S237] The banner advertisement transmitter 122 refers to the issued coupon management table 114a (see FIG. 9) of the coupon issue/use management DB 114, and acquires the number of issued coupons which are of the same type as the coupon to be issued. For example, the banner advertisement transmitter 122 Ands the customer ID received in step S232 or the customer ID registered in step S233 and the coupon ID acquired in step S235 to search the issued coupon management table 114a. The number of issued coupons detected by thus searching the issued coupon management table 114a represents the number of issued coupons which are of the same type as the coupon to be issued.

[step S238] The banner advertisement transmitter 122 determines whether the number of issued coupons of the same type exceeds the upper limit number by issuing a new coupon or not. If the number of issued coupons of the same type exceeds the upper limit number, control goes to step S240. If the number of issued coupons of the same type does not exceed the upper limit number, control goes to step S239.

[step S239] The banner advertisement transmitter 122 registers information of the issued coupon in the issued coupon management table 114a. Specifically, the banner advertisement transmitter 122 registers the customer ID received in step S232 or registered in step S233 in the issued coupon management table 114a. Then, the banner advertisement transmitter 122 acquires an advertisement type ID corresponding to the coupon ID acquired in step S235 from the advertisement information table 112b of the advertisement DB 112, and registers the advertisement type ID in the issued coupon management table 114a. The banner advertisement transmitter 122 acquires an expiry date of the coupon corresponding to the coupon ID acquired in step S235 from the coupon information table 111a, and registers the expiry date in the issued coupon management table 114a. The banner advertisement transmitter 122 determines the present date and time, registers the present date and time as a date of issue, and determines whether the present date and time is within the expiry date. If within the expiry date, then the banner advertisement transmitter 122 registers an effective flag “effective”, and if not within the expiry date, then the banner advertisement transmitter 122 registers an banner advertisement transmitter 122 registers an effective flag “ineffective”.

[step S240] The banner advertisement transmitter 122 acquires graphic data of a banner advertisement specified by a URL from the advertisement DB 112, and transmits the graphic data to the user terminal.

When the user browses through the Web site of the portal site, the corresponding banner advertisement on the display screen of the user terminal. A preset coupon added to the displayed banner advertisement is then issued to the user.

A process of using a coupon will be described below.

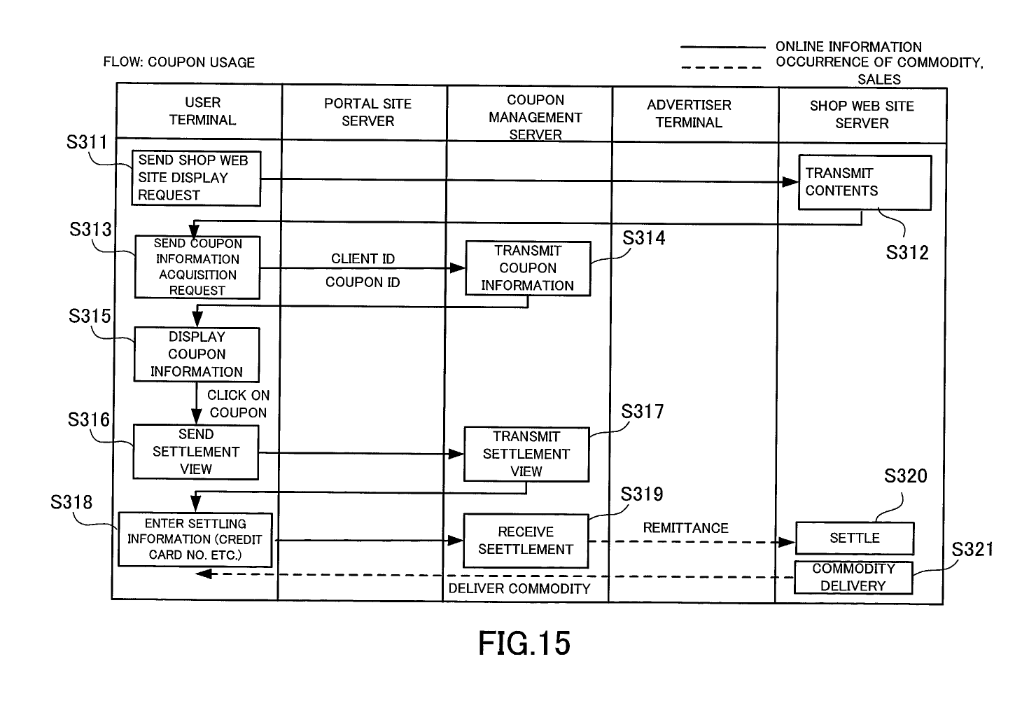

FIG. 15 shows a process of using a coupon. The user uses the user terminal 41 to transmit a request to display the home page of the shop Web site to the shop Web site server 33 in step S311. In response to the request to display the home page, the shop Web site server 33 transmits contents (the commodity name and the price) contained in the home page specified by the request to display the home page to the user terminal 41 in step S312. To the home page transmitted from the shop Web site server 33, there is related the coupon ID of a coupon that can be used to purchase the commodity. The user terminal 41 transmits a request to acquire coupon information defined as an inline image in the HTML document of the home page to the coupon management server 10 in step S313. The request to acquire coupon information contains a coupon ID and a client ID. The client ID is included in a cookie that is stored in the user terminal 41 when the banner advertisement provided by the coupon management server 10 is displayed.

Having received the request to acquire coupon information, the coupon management server 10 transmits the coupon information to the user terminal 41 in step S314. The user terminal 41 adds the coupon information transmitted from the coupon management server 10 to the contents transmitted from the shop Web site server 33, and displays them on its display screen in step S315.

When the user clicks on the coupon information displayed on the display screen, i.e., moves the mouse cursor on the coupon information and presses a button on the mouse, the user terminal 41 transmits a settlement view request to the coupon management server 10 in step S316. In response to the settlement view request, the coupon management server 10 transmits a settlement view in step S317 to the user terminal 41. The user terminal 41 displays the settlement view transmitted from the coupon management server 10 on the display screen, and the user enters settlement information in a information input window in the settlement view displayed on the user terminal 41. The user terminal 41 then transmits a purchase application included the entered settlement information to the coupon management server 10 in step S318.

The coupon management server 10 receives the purchase application and produces a sales contract. Thereafter, the coupon management server 10 performs a settling process. The administrator of the coupon management server 10 collects money from the user according to the settling process, and remits the collected money to the person who is running the shop in step S319. The person who is running the shop confirms the remittance, and performs its own settling process in the shop in step S320. Thereafter, the person who is running the shop delivers the purchased commodity to the user in step S321.

Details of a process carried out by the coupon management server 10 at the time a coupon is used will be described as a process of transmitting coupon information and a process of settling a coupon.

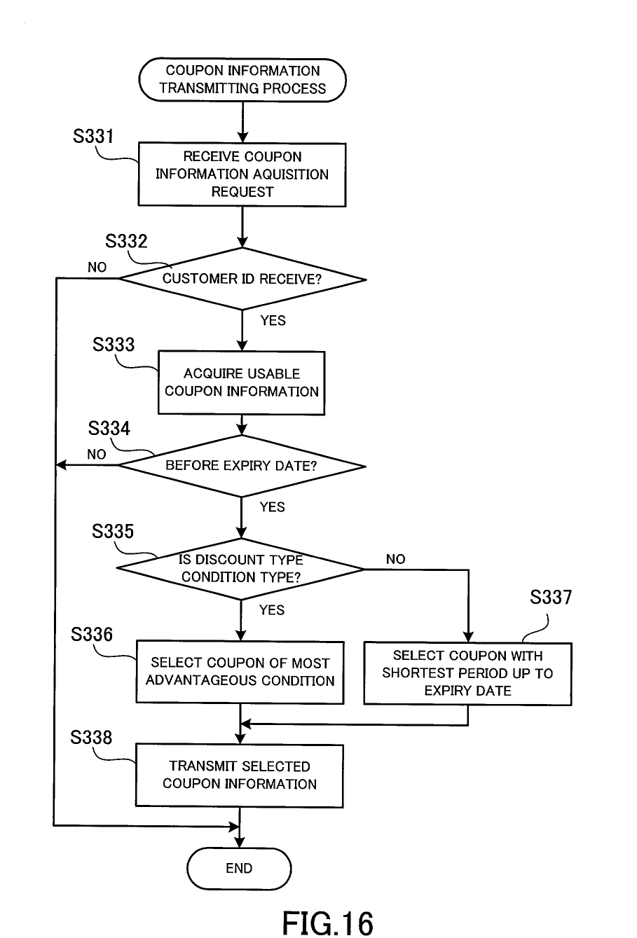

FIG. 16 is a flowchart of a process of transmitting coupon information in the coupon management server 10. The process shown in FIG. 16 will be described below in a sequence according to step numbers.

[step S331] The coupon information transmitter 123 (see FIG. 5) of the coupon management server 10 receives a coupon information acquisition request from the user terminal.

[step S332] The coupon information transmitter 123 determines whether a customer ID has been received or not. The customer ID is sent as a cookie. If a customer ID has been received, the user of the user terminal which has issued the coupon information acquisition request is the user who has downloaded a banner advertisement from the coupon management server 10 in the past. Therefore, if a customer ID has been received, then control goes to step S333. If a customer ID has not been received, then since the coupon information acquisition request has been issued from the user of a user terminal which has not downloaded a banner advertisement from the coupon management server 10 in the past, the process of transmitting coupon information is put to an end.

[step S333] The coupon information transmitter 123 refers to the coupon management DB 111 (see FIG. 6) and the coupon issue/use management DB 114 (see FIG. 9), and acquires usable coupon information. Specifically, the coupon information transmitter 123 refers to the coupon information table 111a in the coupon management DB 111, and acquires information of the coupon corresponding to the coupon ID sent from the user terminal. The coupon information transmitter 123 then acquires all issued coupons corresponding to the set of the coupon ID and the customer ID transmitted from the user terminal, from the issued coupon management table 114a.

[step S334] The coupon information transmitter 123 determines whether the present date and time falls within the expiry date of at least one issued coupon or not. If the present date and time falls within the expiry date of at least one issued coupon, then control goes to step S335. If the present date and time does not fall within the expiry date of at least one issued coupon, then the process of transmitting coupon information is finished. Stated otherwise, if a coupon that has not expired is not issued to the user, then the coupon information transmitter 123 will transmit no coupon information.

[step S335] The coupon information transmitter 123 determines whether the discount type of a coupon that has not expired is of the condition type or not, i.e., whether the “condition type” is registered for the discount type of the coupon information acquired in step S333. If the “condition type” is registered, then control goes to step S336. If the “condition type” is not registered, then control goes to step S337.

[step S336] The coupon information transmitter 123 calculates a discount amount if the discount conditions of the coupon that have been satisfied are applied. The coupon information transmitter 123 selects a coupon of the most advantageous condition among issued coupons which have satisfied the conditions. Specifically, the coupon information transmitter 123 refers to the discount condition table 111b, and determines whether conditions set for the coupon ID of the coupon issued to the user terminal have been satisfied or not. If the conditions have been satisfied, then the coupon information transmitter 123 calculates a discount amount if the conditions are applied.

For example, in the coupon management DB 111 shown in FIG. 6, the discount type of the coupon ID “303” is the “condition type”. If the user of the customer ID “502” makes a request to acquire coupon information of the coupon ID “303”, then it can be understood from the issued coupon management table 114a shown in FIG. 9 that the coupon ID “303” has been issued to the customer ID “502”. The coupon information transmitter 123 determines whether the user of the client ID “502” satisfies the conditions of the coupon ID “303” or not. In the example shown in FIG. 6, two conditions are set for the coupon ID “303”.

The first condition is that “the amount of money spent to purchase commodities should be 10000 yen or more”. For example, when a cup of glass is purchased, since the price of a cup of glass is “1000 yen” (see FIG. 11), this condition is not satisfied. The second condition is that “the consumer should also have a coupon of coupon ID 301”. The user of the client ID “502” has the coupon ID “301” (see FIG. 9). Therefore, the coupon information transmitter 123 calculates a discount amount if the second condition is applied. In the example shown in FIG. 6, since the discount rate is 15%, if a cup of glass whose price is 1000 yen is purchased, then the discount amount is 150 yen. If the first condition is applicable, then the discount amount is 100 yen (10%). If both of the conditions are applicable, then the second condition is applied.

In this manner, a discount amount is calculated if the condition or conditions are satisfied, providing the condition in which the discount amount is greatest. Thereafter, control goes to step S338. If there are available a plurality of coupons where the condition for the greatest discount is applicable, then the coupon information transmitter 123 selects one of those coupons whose expiry date is the nearest.

[step S337] The coupon information transmitter 123 selects a coupon whose expiry date is the nearest, i.e., a coupon whose expiry data comes first.

[step S338] The coupon information transmitter 123 transmits the coupon information of the selected coupon to the user terminal.

In this manner, the coupon information of a coupon to which the most advantageous condition for the user is applicable is transmitted to the user terminal.

Details of a settling process performed by the coupon management server 10 will be described below.

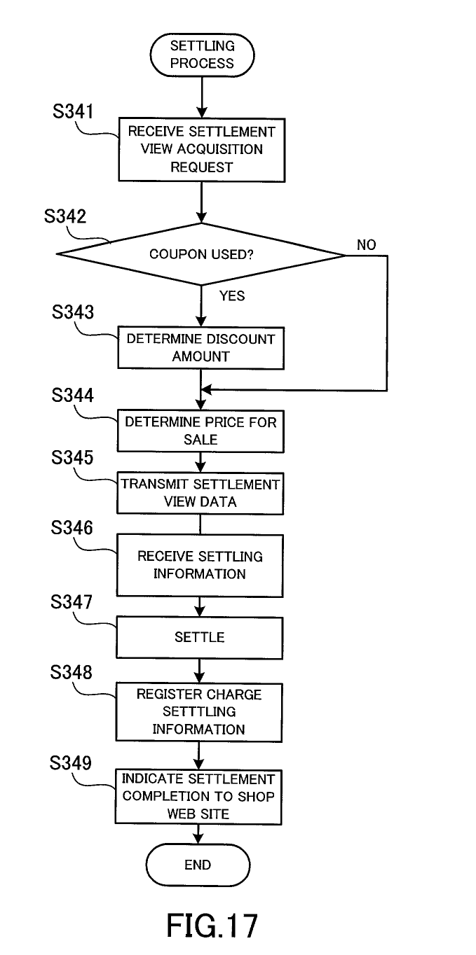

FIG. 17 is a flowchart of a process of settling a coupon in the coupon management server 10. The process shown in FIG. 17 will be described below in a sequence according to step numbers.

[step S341] The settlement manager 124 (see FIG. 5) of the coupon management server 10 receives a settlement view acquisition request from the user terminal. If the settlement view acquisition request is based on a coupon, then the settlement view acquisition request is transmitted together with a client ID and a coupon ID from the user terminal.

[step S342] The settlement manager 124 determines whether a coupon is used or not. If a coupon is used, then control goes to step S343. If a coupon is not used, then control goes to step S344.

[step S343] The settlement manager 124 determines a discount amount based on the use of a coupon. In determining a discount amount, the settlement manager 124 determines a coupon to be applied according to the same processing as the processing in steps S333 through S337 shown in FIG. 16. If a discount rate is specified in the coupon information, then the settlement manager 124 refers to the commodity information table 116b shown in FIG. 11 to acquire the price of the commodity, and calculates a discount amount based on the price of the commodity.

[step S344] The settlement manager 124 refers to the commodity information table 116b shown in FIG. 11 and determines a price for sale by subtracting the discount price from the price of the commodity (fixed price). If no coupon is used, the fixed price becomes the price for sale.

[step S345] The settlement manager 124 transmits settlement view data presenting the price for sale to the user terminal.

[step S346] The settlement manager 124 receives settling information transmitted from the user terminal.

[step S347] The settlement manager 124 performs a settling process. Specifically, the settlement manager 124 determines a settling means with the settling information. The settlement manager 124 transmits the settling information to the banking organization server of the banking organization that is indicated by the settling means, and asks the banking organization server to carry out the settling process. At this time, the settlement manager 124 registers data of corresponding types in the columns of names, contact places, and settling means in the user information management table 113a based on the settling information.

[step S348] The settlement manager 124 registers charge settling information in the charge settlement management DB 115. Specifically, when the settlement manager 124 receives a notice of settlement completion from the banking organization server, the settlement manager 124 refers to the coupon information table 111a (see FIG. 6), and acquires a shop ID and a commodity code which correspond to the coupon ID of the coupon to be used. The settlement manager 124 then registers the customer ID, the shop ID, and the commodity code in the charge settlement management table 115a of the charge settlement management DB 115. The settlement manager 124 also registers data of the charged amount, the charged date, the remittance flag, and the commodity delivery flag in the charge settlement management table 115a. The charged amount is an amount of money determined in step S344. The charged date is a date on which the settling process is performed. In the initial stage, the nonremitted state is registered in the remittance flag. When the administrator of the coupon management server 10 remits the charged amount to the shop, the remittance flag is set to the remitted state. In the initial stage, the commodity delivery flag is set to the non-delivered state. When a notice indicative of the delivery of the commodity from the shop is provided, the commodity delivery flag is set to the delivered state.

[step S349] The settlement manager 124 transmits a notice of settlement completion to the shop Web site server 33.

In the present embodiment, the information of issued coupons is stored in the coupon management server 10. The user occasionally wants to know which coupons have been issued to the user. The coupon management server 10 has a function to indicate the information of issued coupons to the user of the user terminal in response to a request from the user terminal.

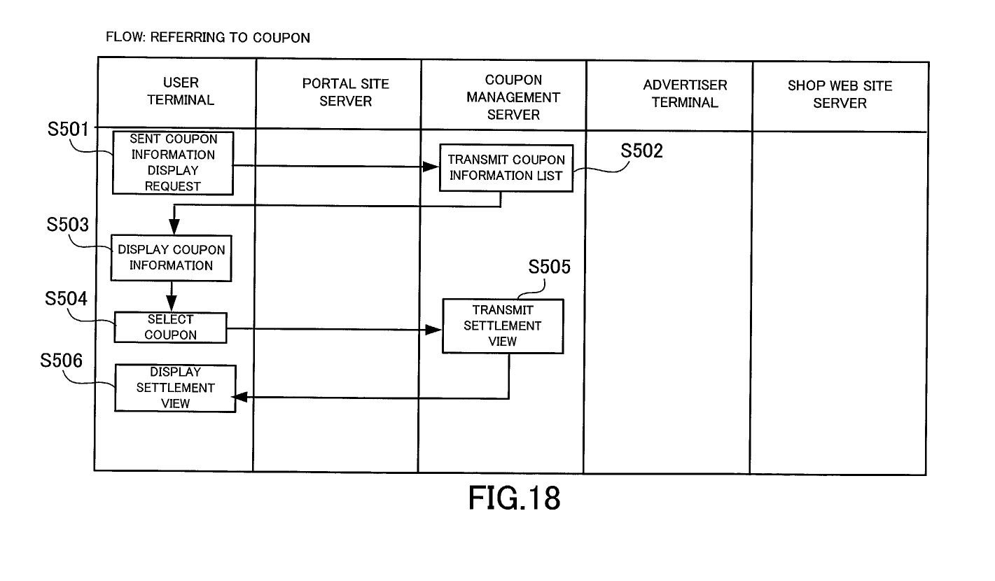

FIG. 18 shows a process of referring to a coupon. The user uses the user terminal 41 to transmit a coupon information display request (benefit inquiry request) to the coupon management server 10 in step S501. At this time, the client ID is transmitted on a cookie to the coupon management server 101. The coupon information transmitter 123 of the coupon management server 101 acquires coupons issued to the client ID that has been transmitted with the coupon information display request, from the coupon issue/use management DB 114. The coupon information transmitter 123 generates a list of acquired coupon information, and transmits the list to the user terminal 41 in step S502. The user terminal 41 displays the coupon information transmitted from the coupon management server 10 in step S503. The user selects one of the coupons displayed on the user terminal 41 in step S504. At this time, a settlement view acquisition request is transmitted from the user terminal 41 to the coupon management server 10. In response to the settlement view acquisition request, the coupon management server 10 transmits a settlement view to the user terminal 41 in step S505, whereupon the user terminal 41 displays the settlement view in step S506. Subsequently, the same process as the settling process is carried out.

In this manner, the user acquires information of coupons that the user can use, and specifies one of the coupons thereby to be able to purchase a commodity at a discount with the coupon. Therefore, the user can purchase the commodity without having to access the shop Web site server, with great convenience to the user.

Actions that the user makes on the user terminal will be described below with respect to an example of displayed views.

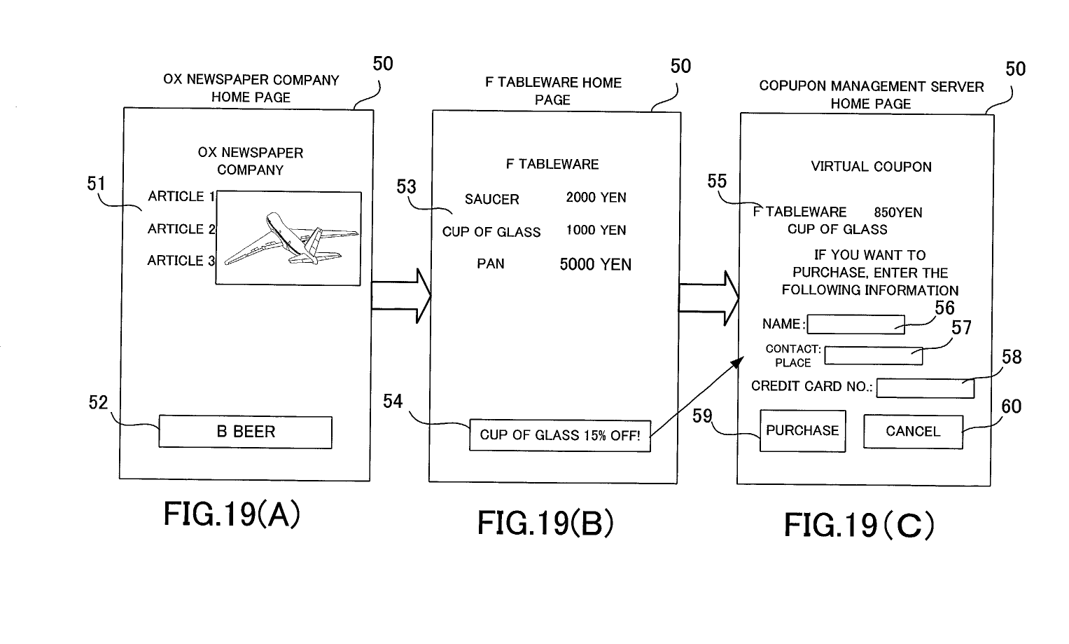

FIGS. 19(A), 19(B), and 19(C) show an example of views displayed on the user terminal. In the example, a banner advertisement of beer is carried on the home page of a newspaper company, and a consumer who has seen the banner advertisement is given a coupon which allows the consumer to purchase a cup of glass at a discount.

FIG. 19(A) shows a home page browsing view displayed on the user terminal. In FIG. 19(A), the home page of a ◯x newspaper company is displayed in a view 50, which displays articles 51 provided by the ◯x newspaper company. The view 50 also displays a banner advertisement 52 of B beer in a lower portion thereof. When the view 50 is displayed on the display screen of the user terminal, the user of the user terminal is given a coupon which allows the user to purchase a cup of glass of an F tableware company at a discount.

At a later time, when the user accesses the home page of the F tableware company and opens an online shopping view of commodities provided for sale by the F tableware company, the information of the coupon is displayed on the display screen of the user terminal.

FIG. 19(B) shows the online shopping view displayed on the user terminal. In FIG. 19(B), the home page of the F tableware company is displayed in a view 50. The home page of the F tableware company displays a list 53 of commodities offered for online shopping. Each of the commodities is accompanied by a price for sale. In the illustrated example, a saucer is offered for sale at 2000 yen, a cup of glass at 1000 yen, and a pan at 5000 yen. The view 50 also displays coupon information 54 in a lower portion thereof.

When the user selects, i.e., clicks on, the coupon information 54 with a mouse or the like, the home page (settlement view) of the coupon management server 10 is displayed on the display screen of the user terminal.

FIG. 19(C) shows a settlement view displayed on the user terminal. As shown in FIG. 19(C), a view 50 displays settlement view data in the home page of the coupon management server 10. The settlement view includes a commodity information display area 55 which displays the name of the shop (F tableware company) for selling the commodity to be purchased, the name of the commodity (cup of glass), and the price for sale (850 yen). The price for sale displayed in the view 50 is a discount price based on the use of the coupon. In the illustrated example, therefore, the price which is 15% off the ordinary price of 1000 yen is displayed.

The view 50 also has a settling information entry area in its lower portion. The settling information entry area includes a name entry window 56, a contact place entry window 57, and a credit number entry window 58. The name entry window 56 serves to enter the name of the user. The contact place entry window 57 serves to enter the address of the user. The credit number entry window 58 serves to enter the number of the credit card which the user uses for settling the purchase.

The view 50 also has a purchase button 59 and a cancel button 60 below the settling information entry area. The purchase button 59 is pressed when the settling information has been entered and the commodity is to be purchased. When the purchase button 59 is pressed, the data entered in the settling information entry area are transmitted to the coupon management server 10. The cancel button 60 is pressed when the purchase is to be canceled. When the cancel button 60 is pressed, the settling information is not transmitted, and the settlement view is closed.

As described above, the consumer who uses the user terminal can acquire a coupon by seeing an advertisement, and use the coupon to purchase a certain commodity at a discount price. Therefore, the consumer is motivated to see the advertisement positively. As a result, the advertiser can obtain a high adverting effect for the commodity carried on the advertisement.

Furthermore, the benefit is given from the advertiser to the consumer when the commodity is sold to the consumer. Therefore, even when a consumer sees the advertisement, but does not contribute to an increase in the sale of the commodity, no benefit is given to the consumer, and hence the advertiser and the seller are prevented from suffering an expenditure of wasteful expenses.

In the present embodiment, each coupon has a usable period, i.e., an expiry date. There may be provided a certain period after which the user is able to use the coupon actually after the user has acquired the coupon. For example, a coupon for a certain commodity may be given to a consumer a certain period of time before the commodity is actually offered for sale. Such a coupon is similar to an advance ticket. The willingness of consumers to buy a certain commodity is aroused before the commodity is actually offered for sale. In this manner, it is possible to make a commodity highly attractive when it is offered for sale as a new product.

In the present embodiment, the information of issued coupons is managed by the coupon management server, and hence is prevented from being falsified by the user. The processing burden on the user terminal is small because the user terminal is not required to manage the coupon information.

In the present embodiment, the advertiser and the seller (the person who is running the shop) may be different companies. As a result, flexibility is given in meeting demands of the advertiser. For example, when a consumer sees an advertisement for a movie (the advertiser is the movie distribution company), a discount ticket for a toy figure (the seller is the toy selling company) of a character appearing in the movie may be handed to the consumer.

In the above description, a benefit for discounting a commodity is given as a coupon. However, a benefit based on a coupon may be other than a discount. For example, a right to acquire a present may be used as a benefit as a coupon. In such a case, when a commodity is purchased using a coupon, both the commodity and the present are given to the purchaser.

In the above description, coupon information is presented to the user, and thereafter an application for purchasing a commodity is received. However, a process for settling the purchase of a commodity using a coupon may be carried out without presenting coupon information. For example, if the user already knows that there is a benefit based on a coupon, then coupon information may not be presented to the user in advance.

In the above description, the advertiser and the seller are different from each other. However, the advertiser and the seller may be one company.

In the above description, a commodity which is advertised and a commodity to which a coupon is applied are different from each other. However, a coupon may be applied to a commodity which is advertised.

The principles of present invention are applicable to various uses as follows:

[Treasure hunting game]

The advertiser registers an advertisement associated with a coupon in a site provided by a contents server, and announces to consumers that there is a coupon (treasure) for a commodity somewhere in the site. A consumer who is thinking about purchasing the commodity browses through all pages in the site in order to purchase the commodity at a discount. As a result, many pages are seen by the consumer, making it possible to advertise other commodities in those pages.

[Puzzle-type coupon]

Fragments of one coupon are placed in a plurality of sites, and the coupon can be used when all the fragments are gathered. Thus, a plurality of sites are seen by consumers until the coupon can be used, making it possible to advertise other commodities in those sites. Coupon fragments alone may not allow consumers to enjoy a benefit, or may allow consumers to enjoy a limited benefit.

[Inductive coupon]

A coupon is set for contents comprising a plurality of views (pages). When the pages are successively seen and all the views of the contents are displayed on the user terminal, the user can use the coupon. Until the user can use the coupon, the user needs to see a plurality of views, making it possible to advertise other commodities in those views.

[Quiz-type coupon]

A quiz is offered in a home page, and a coupon is given to a user who has answered the quiz. Since the user continuously sees the home page while thinking about the quiz, commodities advertised in the home page have a high advertising effect. When an advertisement is displayed in the home page, therefore, the user is prevented from quickly changing to another home page without seeing the advertisement, and tends to see the advertisement continuously for a long time.

[Lottery coupon]

Only a lottery ticket for a coupon is given to a user who has seen an advertisement in a home page. At a suitable time, a lottery is held, and winners are revealed in the home page. The user who has a lottery ticket accesses the home page again to confirm whether the user has won the lottery or not. Therefore, users repeatedly visit and see the home page.

In the above various applications, the distribution of coupons incorporates some elements of play, reducing the tendency of users to dislike the sales approach that forces them to see advertisements.

The above processes can be performed by having the server computer and the client computer run programs. Such programs include a server program containing processing details of functions that the coupon management server is to perform and a client program containing processing details of functions that the user terminals are to perform. When the server program is executed by the server computer, the processing functions of the coupon management server are realized on the server computer. When the client program is executed by the client computer, the processing functions of the user terminal are realized on the client computer.

The server program and the client program, each containing processing details, can be recorded on recording mediums that can be read by the computers. Recording mediums that can be read by the computers include a magnetic recording device, an optical disc, a magneto-optical recording medium, a semiconductor memory, etc. Magnetic recording devices include a hard disk (HD), a floppy disk (FD), a magnetic tape, etc. Optical discs include a DVD (Digital Versatile Disc), a CD-ROM (Compact Disc Read-Only Memory), a CD-R (Compact Disc Recordable)/RW (ReWritable), a DVD-RAM (Digital Versatile Disc Random-Access Memory), etc. Magneto-optical recording mediums include an MO (Magneto-Optical) disk.

For distributing the server program and the client program, portable recording mediums such as DVDs, CD-ROMs, etc. which store those programs are offered for sale. Furthermore, the client program may be stored in a memory of the server computer, and then transferred from the server computer to the client computer via a network.

The server computer which executes the server program stores the server program stored in a portable recording medium into its own memory. Then, the server computer reads the server program from its own memory, and performs processing sequences according to the server program. Alternatively, the server computer may directly read the server program from the portable recording medium and perform processing sequences according to the server program.

The client computer which executes the client program stores, into its own memory, the client program which is either recorded in a portable recording medium or transferred from the server computer. Then, the client computer reads the client program from its own memory, and performs processing sequences according to the client program. Alternatively, the client computer may directly read the client program from the portable recording medium and perform processing sequences according to the client program. Each time the client program is transferred from the server computer to the client computer, the client computer may perform processing sequences according to the client program that has been received.

According to the present invention, as described above, coupon information is stored in association with a terminal device to which advertisement information has been transmitted, and, based on the coupon information associated with the terminal, a benefit is given to a consumer when the consumer purchases a commodity. Therefore, users who want to have coupons can be guided to see advertisements, resulting in a high advertising effect. Since the benefit is given only when the consumer purchases the commodity, no benefit is given to users who are not interested in advertised details and the commodity. Consequently, a high sales promotion capability can be achieved with small advertising expenses.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A method of distributing an advertisement with a computer over a network, comprising the steps of:
managing coupon information which defines a benefit upon purchase of a given commodity and advertisement information in association with said coupon information, and transmitting said advertisement information to a terminal which is connected via said network in response to a request from said terminal;
storing said coupon information associated with said advertisement information transmitted to said terminal, in association with said terminal;
referring to said coupon information stored in association with said terminal and determining a benefit upon purchase of the given commodity in response to a benefit inquiry request for said given commodity from said terminal; and
indicating the determined benefit to said terminal.

2. A method according to claim 1, wherein the benefit defined by said coupon information represent a discount to be offered upon purchase of the given commodity.

3. A method according to claim 2, wherein said coupon information represents a discount amount to be offered upon purchase of the given commodity.

4. A method according to claim 2, wherein said coupon information represents a discount rate to be offered upon purchase of the given commodity.

5. A method according to claim 1, wherein said coupon information represents an expiry date and can be used only prior to said expiry date.

6. A method according to claim 5, wherein said coupon information represents a period after which a user is able to use a coupon actually after the user has acquired the coupon.

7. A method according to claim 1, further comprising the steps of:
referring to said coupon information stored in association with said terminal and determining a benefit upon purchase of the given commodity in response to an application for the purchase of the given commodity from said terminal; and
producing a sales contract for the given commodity with the determined benefit applied, and settling the purchase of the given commodity based on the sales contract.

8. A method according to claim 7, wherein the purchase of the given commodity is settled by asking a banking organization server which can withdraw money from an account of the user of said terminal, to withdraw an amount of money based on the sales contract from the account of the user of said terminal.

9. A method according to claim 7, wherein said coupon information represents a condition in which said benefit is applicable, and the benefit defined by said coupon information is applied to the sales contract only when said condition is satisfied upon the purchase of the given commodity.

10. A method according to claim 9, wherein said coupon information defines a plurality of benefits which are applicable under different conditions, and one of the benefits which is most advantageous for the user is applied to the sales contract among those benefits whose conditions are satisfied upon the purchase of the given commodity.

11. A method of distributing an advertisement with a computer over a network, comprising the steps of:
managing coupon information which defines a discount amount upon purchase of a given commodity and advertisement information in association with said coupon information, and transmitting said advertisement information to a terminal which is connected via said network in response to a request from said terminal;
storing said coupon information associated with said advertisement information transmitted to said terminal, in association with said terminal;
referring to said coupon information stored in association with said terminal and determining a price upon purchase of the given commodity in response to an application for the purchase of the given commodity from said terminal; and
producing a sales contract for the given commodity with the determined price applied, and settling the purchase of the given commodity based on the sales contract.

12. An apparatus for distributing an advertisement over a network, comprising:
advertisement transmitting means for managing coupon information which defines a benefit upon purchase of a given commodity and advertisement information in association with said coupon information, and transmitting said advertisement information to a terminal which is connected via said network in response to a request from said terminal;
coupon information storing means for storing said coupon information associated with said advertisement information transmitted to said terminal, in association with said terminal;
determining means for referring to said coupon information stored in association with said terminal and determining a benefit upon purchase of the given commodity in response to a benefit inquiry request for said given commodity from said terminal; and
indicating means for indicating the determined benefit to said terminal.

13. A method of browsing through an advertisement distributed over a network, comprising the steps of:
acquiring first contents to which advertisement information is related, via said network;
acquiring the advertisement information related to said first contents, from a coupon management server via said network;
storing an identifier transmitted from said coupon management server;
displaying said first contents and said advertisement information;
acquiring second contents including a list of commodities to which types of coupon information defining a benefit upon the purchase of commodities are related, via said network;
transmitting said types of coupon information related to the list of commodities included in said second contents and said identifier to said coupon management server to acquire usable coupon information from said coupon management server; and
displaying said second contents and said usable coupon information.

14. A program for distributing an advertisement over a network by controlling a computer to perform a process comprising the steps of:
managing coupon information which defines a benefit upon purchase of a given commodity and advertisement information in association with said coupon information, and transmitting said advertisement information to a terminal which is connected via said network in response to a request from said terminal;
storing said coupon information associated with said advertisement information transmitted to said terminal, in association with said terminal;
referring to said coupon information stored in association with said terminal and determining a benefit upon purchase of the given commodity in response to a benefit inquiry request for said given commodity from said terminal; and
indicating the determined benefit to said terminal.

15. A recording medium readable by a computer and storing a program for distributing an advertisement over a network by controlling the computer to perform a process comprising the steps of:
managing coupon information which defines a benefit upon purchase of a given commodity and advertisement information in association with said coupon information, and transmitting said advertisement information to a terminal which is connected via said network in response to a request from said terminal;
storing said coupon information associated with said advertisement information transmitted to said terminal, in association with said terminal;
referring to said coupon information stored in association with said terminal and determining a benefit upon purchase of the given commodity in response to a benefit inquiry request for said given commodity from said terminal; and
indicating the determined benefit to said terminal.
